(19) United States
(12) Patent Application Publication
(10) Pub. No.: US 2016/0247211 A2
(43) Pub. Date: Aug. 25, 2016

(54) APPARATUS, SYSTEM, AND METHOD FOR REMOTE MEDIA OWNERSHIP MANAGEMENT

(71) Applicant: John Fenley, Provo, UT (US)

(72) Inventor: John Fenley, Provo, UT (US)

(73) Assignee: VidAngel, Inc., Provo, UT (US)

(21) Appl. No.: 11/608,165

(22) Filed: Dec. 7, 2006

Related U.S. Application Data
(60) Provisional application No. 60/744,011, filed on Dec. 7, 2006.

(51) Int. Cl. G06Q 40/00

(52) U.S. Cl. CPC G06Q 30/06

(57) ABSTRACT

An apparatus, system, and method are disclosed for managing remote media ownership, where the media involve physical media units (PMUs). The system includes a physical media storage facility that stores the PMUs, and a PMU transfer facility that receives PMUs from users and delivers PMUs to users. The system includes a controller that reads an ownership database to determine the PMUs owned by a user. The controller accepts a username and password to authenticate a user, and allows the user to access the content of the PMUs owned by the user upon authentication. The controller may further allow the user to buy PMUs, to sell owned PMUs, and to request delivery of owned PMUs once the user is authenticated.

### CROSS-REFERENCES TO RELATED APPLICATIONS

This application claims the benefit of U.S. Provisional Patent Application No. 60/744,011 entitled “MANAGED, PHYSICAL MEDIA SPACE SHIFTING, WITH REMOTE ACCESS, AND MARKET BASED SALE SYSTEM” and filed on Mar. 30, 2006 for John Fenley, which is incorporated herein by reference.

### BACKGROUND OF THE INVENTION

1. Field of the Invention

This invention relates to remote media ownership management and more particularly relates to managing the remote storage, trading, and access of physical media.

2. Description of the Related Art

Collections of physical media units (PMUs) can represent a substantial investment to a consumer and present a considerable risk of loss or theft. For example, a consumer may own hundreds of music compact discs (CDs) worth thousands of dollars. A music store may own thousands of CDs worth millions of dollars. Further, the ownership of a collection of PMUs may be relatively inconvenient, as the personal use of hundreds of music CDs by an individual consumer often involves searching through the CDs, handling the CDs, putting away CDs, and damaging the CDs. Other physical media collections, such as movie digital video discs (DVDs), game system cartridges and discs, and the like, also suffer from the same limitations.

A consumer also has a relatively difficult time obtaining and disposing of PMUs compared to digital media formats. For example, a consumer can subscribe to a news website from their computer while sitting at home. However, to obtain access to a PMU, the consumer must travel to the store, or at the very least order the PMU online or over the phone and await shipping of the PMU. Further, there are various transaction costs to current mechanisms of selling and trading PMUs, including the shipping costs and waiting times for remotely purchased PMUs, and the travel cost, risk, and time for store-bought PMUs. These costs continue to be incurred when much of the media is in a format that could be easily accessible purely by remote if the media were in digital format—for example over the internet.

However, the PMU stands as an important representation of the license to access the media. The consumer obtains an easily transferable ownership right by owning a PMU that would not exist with electronic-only media formats. If the consumer purchases media content in a purely digital format, and does not like the media content after purchase, they cannot easily sell the rights to the media content to recoup some of their investment. However, if the consumer purchases a PMU, they can easily sell the PMU to another consumer, and the interests of the consumer and the producer of the media content are protected. If the consumer can sell the PMU to another consumer without the transaction costs of advertising, shipping, and waiting, then the interests of the consumer are even more strongly protected without interfering with the interests of the media producers.

### SUMMARY OF THE INVENTION

From the foregoing discussion, applicant asserts that a need exists for an apparatus, system, and method for remote media ownership management. Beneficially, the apparatus, system, and method would allow consumers to access and trade physical media units without the constraints and risks of maintaining the physical media units at the location of the consumer.

The present invention has been developed in response to the present state of the art, and in particular, in response to the problems and needs in the art that have not yet been fully solved by currently available remote media ownership systems. Accordingly, the present invention has been developed to manage remote media ownership of physical media units that overcome many or all of the above-discussed shortcomings in the art.

A system for managing remote media ownership includes a physical media storage facility, an ownership register comprising a media owner corresponding to each of the plurality of PMUs. Each media owner comprises one of a plurality of users, and each user comprising a legal entity. The system further includes a PMU transfer facility that receives an incoming PMU and ownership information corresponding to the incoming PMU. The PMU transfer facility stores the incoming PMU in the physical media storage facility, and updates the ownership register according to the incoming PMU and the ownership information. The system further includes a controller comprising a plurality of modules configured to functionally execute managing remote media ownership. The modules may include a registration module configured to interpret the ownership register, an authentication module configured to interpret a username input and a password input from a current user, and to authenticate the current user as the media owner for a set of current PMUs according to the username input, the password input, and the ownership register. The controller may further include a content control module configured to manage ownership rights regarding the set of current PMUs for the current user, wherein ownership rights include one or more of a right to use, to dispose of, and to possess the current PMUs.

In one embodiment, the controller further includes a selling module configured to accept a seller-bid comprising a seller-specified PMU from the set of current PMUs, a buying module configured to accept a buyer-bid comprising a buyer-specified PMU, and a trading module configured to execute a PMU trade in response to the seller-specified PMU matching the buyer-specified PMU. The trading module may further update the ownership register based on the PMU trade. The seller-bid may be a market bid and/or a limit bid, and the seller-bid may be a market bid with a trigger price. The buyer-bid may be a market bid and/or a limit bid, and the buyer-bid may be a market bid with a trigger price.

The controller further comprises a fiscal module configured to deduct a trade price from a first user account corresponding to a first user associated with the buyer-bid, and to add the trade price to a second user account corresponding to a second user associated with the seller-bid. The fiscal module may also deduct at least one commission from at least one of the first user account and the second user account, and/or collect taxes from at least one of the first user account and the second user account. The fiscal module may estimate a collateral value of PMUs corresponding to a media owner based on the ownership register, and to extend credit to a user account corresponding to the media owner based on the collateral value. The fiscal module may further track a plurality of user accounts corresponding to the plurality of users, and deduct a PMU storage fee from a user account corresponding to one of the media owners based on the ownership register.

The password input may be an access password, an ownership password, and/or an inventory password. The content control module may limit a user to access of the the content of PMUs where the user inputs the access password, and the content control module may further allow trading and delivery of PMUs where the user inputs the ownership password. Access to the content of PMUs may be access to a digital media equivalent of the PMUs, and access to the content of a damaged PMU may be access to a digital media equivalent of an undamaged copy of the PMU.

The controller may include an inventory module that accepts an inventory target, a buying price target, a selling price target, and a PMU designation from the current user. The inventory module may interpret an inventory level of the designated PMU for the current user based on the ownership register. The inventory module may further enter at least one seller-bid for the designated PMU according to the selling price target whenever the inventory level of the designated PMU is at least one unit, and enter at least one buyer-bid for the designated PMU according to the buying price target whenever the inventory level of the designated PMU is lower than the inventory target. The authentication module may be configured to allow the current user to enter an inventory target, a buying price target, a selling price target, and a PMU designation in response to the current user entering the inventory password. The inventory module may further accept a pending buyer-bids target, and maintain a number of buyer-bids for the designated PMU no greater than the pending buyer-bids target.

The content control module may further accept a delivery order from the current user, and initiate a delivery of at least one of the current PMUs in response to the delivery order. Each PMU in the system may be a medium for audio content, a medium for video content, a medium for digital game content, and/or a medium for multimedia content. In one embodiment, each PMU in the system may be printed media, a vinyl audio record, a magnetic tape, a picture, and/or a painting, wherein access to the content of each PMU may comprise access to a digital representation of each PMU.

An apparatus is disclosed for managing media ownership. The apparatus includes an ownership database comprising a plurality of users, a plurality of media owners, each media owner corresponding to one of the plurality of users, and a plurality of physical media units (PMUs), each PMU corresponding to one of the media owners. The apparatus further includes a remote access system comprising a plurality of modules configured to functionally execute managing remote media ownership. The remote access system may include an authentication module, a content control module, and a trading module. The trading module may interpret a buy option allowing a current user to place buyer-bids on any PMUs, and interpret a sell option allowing the current user to place seller-bids on a PMU from the set of current PMUs.

The ownership database may comprise an access authentication information and an ownership authentication information for each of the plurality of users. The authentication module may allow access to the content of the current PMUs in response to the current user entering the access authentication information, and may allow access to the content of the current PMUs, to place seller-bids, and to place buyer-bids in response to the current user entering the ownership authentication information.

The ownership database may further include a physical address record corresponding to each of the plurality of users. The content control module may initiate delivery of one of the current PMUs to the physical address record corresponding to the current user in response to a physical delivery request

The ownership database may further include a set of inventory records, each inventory record comprising a PMU designation, an inventory target, a buying price target, and a selling price target. Each inventory record is associated with one of the plurality of users. The remote access system may further include an inventory module configured to interpret an inventory PMU designation, an inventory target input, a buying price target input, and a selling price target input from the current user according to the inventory records. The inventory module may place a buyer-bid based on the buying price target input for the inventory-designated PMU in response to a current inventory level of the inventory-designated PMU being lower than the inventory target, and may place a seller-bid based on the selling price target input for the inventory-designated PMU in response to the current inventory level of the inventory-designated PMU being at least one PMU.

A method is disclosed for managing remote media ownership in accordance with the present invention. The method may be implemented as a computer program product comprising a computer useable medium including a computer readable program, wherein the computer readable program when executed on a computer causes the computer to perform the method. The method includes interpreting an ownership register comprising a plurality of users, a plurality of media owners, and a plurality of physical media units (PMUs). Each media owner may correspond to one of the plurality of users, and each PMU may correspond to one of the media owners. The method further includes interpreting access input from a current user comprising one of the plurality of users, and authenticating the current user as the media owner for a set of current PMUs according to the access input and the ownership register. The method further includes managing ownership rights regarding the set of current PMUs for the current user.

In one embodiment, the method may include comprising accepting a seller-bid of a seller-specified PMU from a first user comprising an authenticated media owner of the seller-specified PMU, accepting a buyer-bid of a buyer-specified PMU from a second user, and executing a PMU trade in response to the seller-specified PMU matching the buyer-specified PMU. The buyer-bid and seller-bid may each comprise a market order, a stop order, and/or a limit order.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a system for managing media ownership in accordance with the present invention;

FIG. 2 is a schematic block diagram of a controller configured to communicate with users, interpret and update an ownership register, and communicate with a physical media unit (PMU) transfer facility in accordance with the present invention;

FIG. 3 is an illustration of one embodiment of an ownership register in accordance with the present invention;

FIG. 4 is an illustration depicting one embodiment of authentication information in accordance with the present invention;

FIG. 5 is an illustration depicting one embodiment of inventory information in accordance with the present invention;

FIG. 6 is an illustration depicting one embodiment of a web site title screen in accordance with the present invention;

FIG. 7 is an illustration depicting one embodiment of a web site login screen in accordance with the present invention;

FIG. 8 is an illustration depicting one embodiment of a web site content control screen in accordance with the present invention;

FIG. 9 is an illustration depicting one embodiment of a web site trading screen in accordance with the present invention;

FIG. 10 is an illustration depicting one embodiment of a web site inventory screen in accordance with the present invention; and

FIG. 11A is a schematic flow diagram illustrating one embodiment of a method for managing remote media ownership in accordance with the present invention; and

FIG. 11B is a continuing schematic flow diagram illustrating one embodiment of a method for managing remote media ownership in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer programmed product may take any form capable of generating a signal, causing a signal to be generated, or causing execution of a program of machine-readable instructions on a digital processing apparatus. A computer programmed product may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

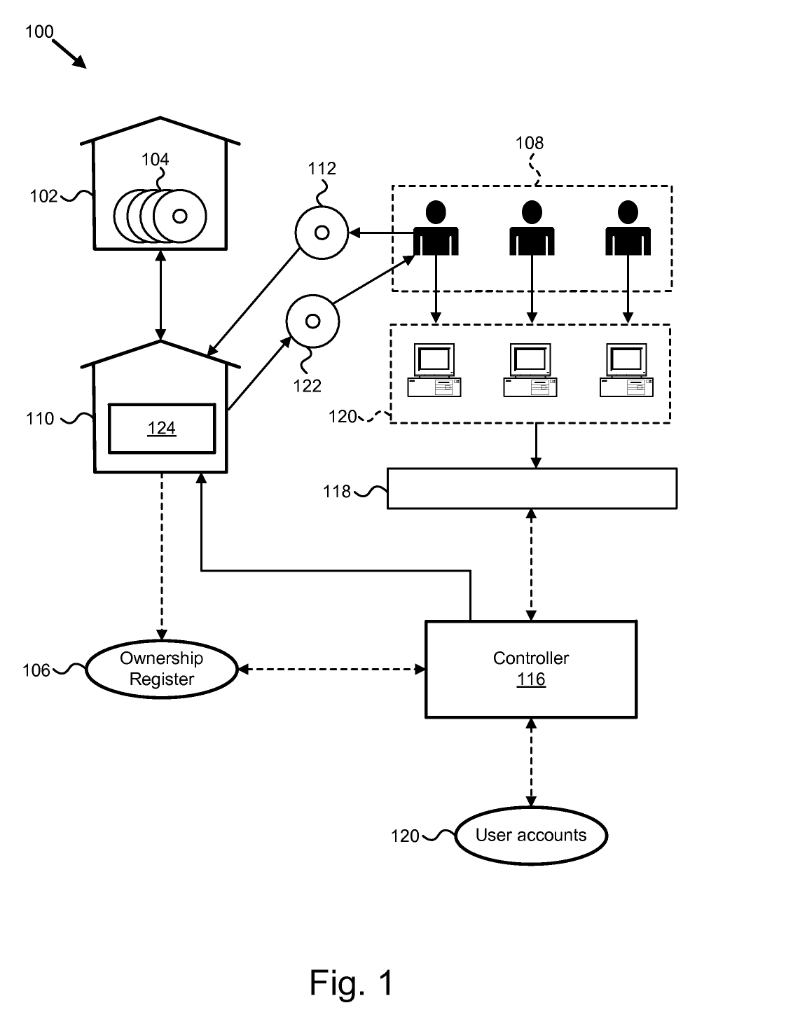

FIG. 1 is a schematic block diagram depicting one embodiment of a system 100 for managing media ownership in accordance with the present invention. The system 100 comprises a physical media storage facility 102 configured to store a plurality of physical media units 104 (PMUs). Each PMU 104 may comprise a medium for audio content, medium for video content, medium for digital game content, and a medium for multimedia content. For example, the PMU 104 may comprise a music compact disc (CD), a PowerPoint presentation on a CD, a movie digital video disc (DVD), and the like. In one embodiment each PMU 104 may comprise printed media, a vinyl audio record, a magnetic tape, a picture, and a painting.

The system 100 may further comprise an ownership register 106 comprising a media owner corresponding to each of the PMUs 104, where each of the media owners comprises one of a plurality of users 108. Each user 108 comprises a legal entity, and may be corporation, an individual, and the like. In one embodiment the ownership register 106 may comprise an ownership database comprising a plurality of users 108 and a plurality of media owners. Each media owner corresponds to one of the plurality of users 108, and each PMU 104 corresponds to one of the media owners.

The system 100 further comprises a PMU transfer facility 110 configured to: receive an incoming PMU 112 and ownership information (not shown) corresponding to the incoming PMU 112, transfer the incoming PMU 112 to the physical media storage facility 102, and to update the ownership register 106 according to the incoming PMU 112 and the ownership information. The PMU transfer facility 110 may be separate from the physical media storage facility 102 as shown in the embodiment of FIG. 1, or the PMU transfer facility 110 may be in the same location as the physical media storage facility 102. The PMU transfer facility 110 may comprise an automated system to recognize and store PMUs 104, and/or a person that manually stores the PMUs 104 and updates the ownership register 106.

The system 100 may further comprise a controller 116 configured to communicate with the users 108, to interpret and update the ownership register 106, and to communicate with the PMU transfer facility 110. The controller 116 may comprise a computer program product on a computer readable medium, and may communicate with the users through a computer network 118 (e.g. the Internet) and computers 120 accessed by the users 108. Some user inputs may occur by phone, fax, mail, and/or other media besides a computer network 118, and these other communication methods are contemplated within the scope of the invention. In one embodiment, the controller 116 may initiate a delivery of a PMU 104 to a user 108, and the PMU transfer facility 110 may retrieve the outgoing PMU 122 from the physical media storage facility 102 and deliver it to the user 108. The PMU transfer facility 110 and/or the controller 116 may update the ownership register 106 to reflect the delivery of an outgoing PMU 122.

The system 100 may further comprise a media verification module 124 configured to identify a damaged incoming PMU 112 as an acceptable representation of ownership of the content of the PMU 112. For example, a music CD 112 with scratches such that the media on the music CD 112 is not playable with a standard CD player may nevertheless clearly be a genuine copy of the music CD 112. In the example, depending upon the law where the system 100 operates, a digital media equivalent (not shown) may be provided to the owning user 108 of the damaged incoming PMU 112 when the owning user 108 requests access to the content of the music CD 112. The media verification module 124 may comprise an automated procedure 124—for example a scanning device and/or digital sampling device configured to positively identify a damaged incoming PMU 112—and/or a person 124 that manually examines the damaged incoming PMU 112. For example, the media verification module 124 may comprise a scanning device configured to determine whether a PMU 112 is legitimate, and to transfer PMUs 112 to a person 124 for verification when the scanning device is unable to make a determination.

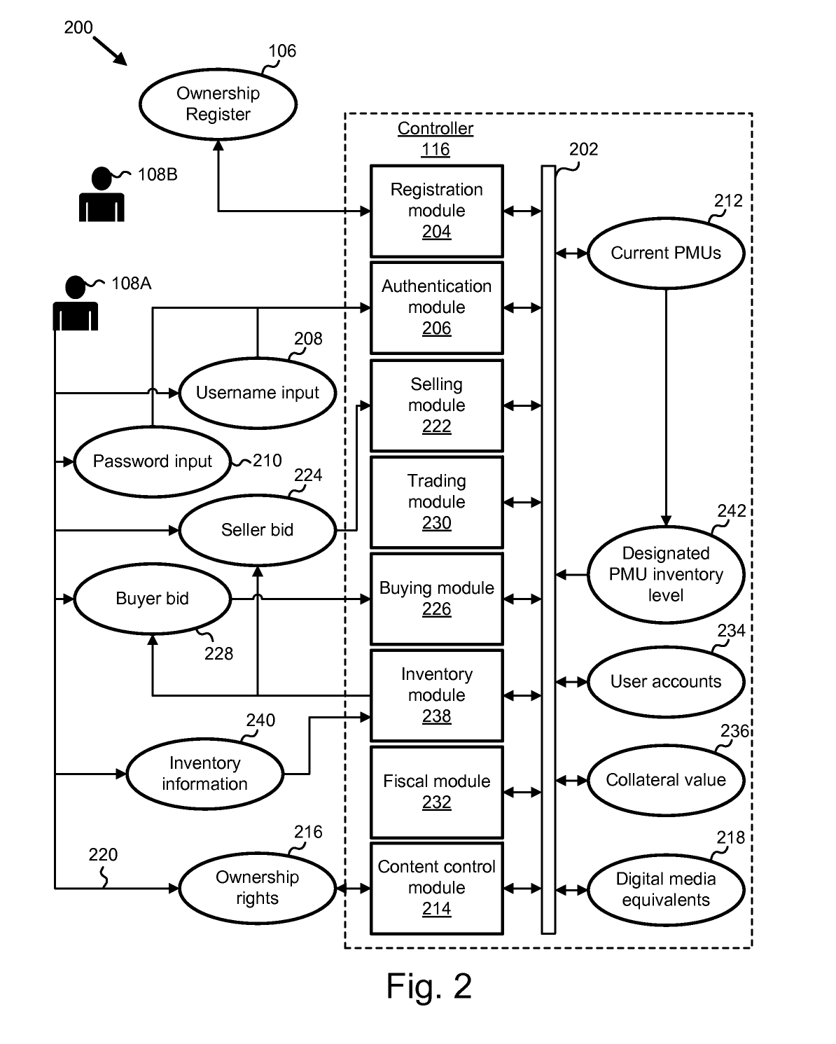

FIG. 2 is a schematic block diagram of a controller 116 configured to communicate with the users 108, to interpret and update the ownership register 106, and to communicate with the PMU transfer facility 110 in accordance with the present invention. The controller 116 may comprise a plurality of modules configured to functionally execute the actions of the controller 116. In one embodiment, the modules of the controller 116 communicate on a communication backbone 202, which may comprise a shared random access memory (RAM) of a computer, database records, communications over a network of computers, and/or combinations of these and other communication sharing devices known in the art. The modules of the controller 116 may also communicate by passing individual information in accordance with the descriptions herein, and the communication backbone 202 is disclosed in one embodiment of the present invention to provide clarity to the description of FIG. 2.

The controller 116 comprises a registration module 204 configured to interpret the ownership register 106. The controller 116 further comprises an authentication module 206 configured to interpret authentication information and to authenticate a current user 108A as the media owner for a set of current PMUs 212 according to the authentication information and the ownership register 106. In one embodiment the authentication information may comprise a username input 208 and a password input 210 from a current user 108A. The authentication information may comprise digital certificates, personal identification numbers, cookies on a computer, biometric recognition, and other security information known in the art. For example, the authentication module 206 may receive a username input 208 and a password input 210 from the current user 108A, check the username input 208 and the password input 210 against a username/pas sword database (not shown), and if a match is confirmed, the authentication module 206 may instruct the registration module 204 to identify the set of PMUs 104 owned by the media owner matching the user name input 208 for the current user 108A. The registration module 204 may store the set of PMUs 104 owned by the current user 108A as the set of current PMUs 212.

The controller 116 further comprises a content control module 214 configured to manage ownership rights 216 regarding the set of current PMUs 212 for the current user 108A. Ownership rights include one or more of a right to use, to dispose of, and to possess the current PMUs 212.

The right to use the current PMUs 212 may comprise access to content of the current PMUs 212. In one embodiment, access to content of the current PMUs 212 comprises access to a digital media equivalent 218 of at least a portion of the content of the current PMUs 212. For example, the current user 108A may request the use of a music CD in the current PMUs 212, and the content control module 214 may provide access to the music CD by playing the CD and digitally sending the results to the current user 108A. Alternatively, the content control module 214 may stream the digital content to a computer 120 or other electronic device operated by the current user 108A. In another example, the current user 108A may request the use of a music CD in the current PMUs 212, and the content control module 214 may provide access to the music CD by streaming music from a separate music database comprising a digital media equivalent 218.

The content control module 214 may be configured to provide access to the content in a manner consistent with the type of content. The content control module 214 may be further configured to provide access to the content according to the usage license held by the media owner for the PMU 104. For example, audio content may be played back as sound and video content may be played back with video and/or sound. In another example the content control module 214 may be further configured to provide multiple user 108 access to PMUs 104 comprising a multiple user license. Other access controls, such as allowing full download of the content of the current PMU 212, single play downloads for each access request, and the like, are contemplated within the scope of the present invention. In one embodiment, the requested PMU 104 from the set of current PMUs 212 may comprise a damaged PMU 104, and the digital media equivalent 218 of at least a portion of the content of the damaged PMU 104 comprises a digital media equivalent 218 of the undamaged content of the damaged PMU 104.

The right to dispose of the current PMUs 212 may comprise the right to sell, give away, or destroy one or more of the current PMUs 212. The right to possess the current PMUs 212 may comprise the right to order delivery of one or more of the current PMUs 212 to be delivered to the current user 108A. The content control module 214 may be configured to accept a delivery order 220 from the current user 108A, and to initiate a delivery of at least one of the current PMUs 212 in response to the delivery order 220. For example, the current user 108A may send a delivery order 220 to the controller 116, and the content control module 214 may accept the delivery order 220, verify any PMUs 104 in the delivery order 220 against the current PMUs 212, and notify the PMU transfer facility 110 of the outgoing PMUs 122 to be delivered to the current user 108A according to the delivery order 220. The content control module 214 or the PMU transfer facility 110 may be configured to update the ownership register 106 upon delivery of the outgoing PMUs 122.

The controller 116 may further comprise a selling module 222 configured to accept a seller-bid 224 comprising a seller-specified PMU 104 from the set of current PMUs 212 for the current user 108A placing the seller-bid 224. For example, the seller-bid 222 may comprise the album name of a music CD. The controller 116 may further comprise a buying module 226 configured to accept a buyer-bid 228 comprising a buyer-specified PMU. The user placing the seller-bid 224 and the user placing the buyer-bid 228 may comprise a first user 108A and a second user 108B, and the bids may be placed at any point in time relative to each other (e.g. buyer first, seller first, and/or simultaneous). The inputs 208, 210, 224, 228 provided by the second user 108B are not shown in FIG. 2 to avoid unnecessary clutter and enhance the clarity of FIG. 2, but equivalent inputs 208, 210, 224, 228 exist for each user 108.

The controller 116 may comprise a trading module 230 configured to execute a PMU trade in response to the seller-specified PMU 104 matching the buyer-specified PMU 104, and to update the ownership register 106 based on the PMU trade. For example, if the seller (e.g. user 108A) entered a seller-bid 224 comprising “Rolling Stones Steel Wheels,” and the buyer (e.g. user 108B) entered a buyer-bid 228 comprising “Rolling Stones Steel Wheels,” the trading module 230 may execute a trade of one “Rolling Stones Steel Wheels” album from the first user 108A to the second user 108B, and the trading module 230 may update the ownership register 106 by notifying the registration module 204 of the ownership transfer. The ownership transfer may comprise an update to the ownership register 106 and/or delivery of the PMU 104 to the buyer.

In one embodiment, the seller-bid 224 may further comprise a seller trigger price, wherein the trading module 230 may be configured to execute the PMU trade only after a trigger PMU sale of greater than the seller trigger price, wherein the trigger PMU sale comprises a PMU 104 matching the seller-specified PMU 104. For example, the seller-bid 224 may comprise “Rolling Stones Steel Wheels, $12 trigger price,” and the trading module 230 may be configured to execute a trade based on the seller-bid 224 at any time after a “Rolling Stones Steel Wheels” PMU sells somewhere in the system for greater than $12.

In one embodiment, the buyer-bid 228 may further comprise a buyer trigger price, wherein the trading module 230 may be configured to execute the PMU trade only after a trigger PMU sale of less than the buyer trigger price, wherein the trigger PMU sale comprises a PMU 104 matching the buyer-specified PMU. For example, the buyer-bid 224 may comprise “Rolling Stones Steel Wheels, $8 trigger price,” and the trading module 230 may be configured to execute a trade based on the buyer-bid 124 at any time after a “Rolling Stones Steel Wheels” PMU sells somewhere in the system for less than $8.

In one embodiment, the seller-bid 224 may further comprise a seller limit price, wherein the trading module 230 is further configured to execute the PMU trade only when an available buyer-bid 228 allows the PMU trade to occur at a price of at least the seller limit price. For example, the seller-bid 224 may comprise “Rolling Stones Steel Wheels, $10 limit price,” and the trading module 230 may be configured to execute a trade based on the seller-bid 224 whenever an available buyer-bid 228 allows the sale at $10 or higher.

In one embodiment, the buyer-bid 228 may further comprise a buyer limit price, wherein the trading module 230 is further configured to execute the PMU trade only when an available seller-bid 224 allows the PMU trade to occur at a price no greater than the buyer limit price. For example, the buyer-bid 228 may comprise “Rolling Stones Steel Wheels, $10 limit price,” and the trading module 230 may be configured to execute a trade based on the buyer-bid 228 whenever an available seller-bid 224 allows the sale at $10 or higher.

For purposes of clarification, it should be understood that the use of a “trigger price” herein is similar to a “stop order” in the securities trading industry. Similarly, the use of a “limit price” herein is similar to a “limit order” in the securities trading industry. Further, an order without a trigger price or a limit price is similar to a “market order” in the securities trading industry. For reference purposes, the definitions of these terms are provided from the U.S. Securities and Exchange Commission website. A stop order is defined as “[A]n order to buy or sell a stock once the price of the stock reaches a specified price, known as the stop price. When the specified price is reached, your stop order becomes a market order.” A limit order is defined as “[A]n order to buy or sell a security at a specific price.” A market order is defined as “[A]n order to buy or sell a stock at the current market price.” See http://www.sec.gov, last visited Nov. 28, 2006. However, the trading mechanisms disclosed herein may, but do not always, have the same purposes as securities trading mechanisms and it should not be assumed that the limitations of analogous securities trading mechanisms apply to the trading mechanisms herein.

For example, the trading module 230 may be configured to determine a “market price” according to average trading prices, the most recent trading prices, based on the price of a new PMU at retail, and the like, at which a trade will occur when a buyer-bid 228 is matched with a seller-bid 224 and neither bid comprises any price indication. The trading module 230 may be further configured to publish the “market price” to the buyer and/or seller before placing the seller-bid 224 and/or buyer-bid 228.

In another example, a “stop order” in the securities industry is often used to either buy a security upon the completion of a technical formation—for example to buy a security when the trader believes the price itself indicates the price is ready to go up, or to exit a position by performing a counter-position order at some trigger price—for example to buy a security that was sold short if the price takes an unexpected drop, and/or to exit a position and protect profits. However, in the present invention, unlike what is generally true in securities, PMUs 104 may hold inherent or aesthetic value, and the future value of a PMU may or may not be important to a trader (i.e. a user 108). Therefore, the concept of a “stop order” as used herein (i.e. the use of “trigger prices”) further includes at least the notion of buying a desired PMU cheap without any consideration of the future value increasing.

The controller 116 may further comprise a fiscal module 232 configured to deduct a trade price from a first user account 234 corresponding to a first user 108A associated with the buyer-bid 228, and to add the trade price to a second user account 234 corresponding to a second user 108B associated with the seller-bid 228. For example, the trading module 230 may execute a trade wherein the first user 108A is the buyer, and the second user 108B is the seller, at a price of $25. The fiscal module 232 deducts $25 from the user account 234 corresponding to the first user 108A and adds $25 to the user account 234 corresponding to the second user 108B.

The fiscal module 232 may be further configured to deduct at least one commission from at least one of the first and second user accounts 234. In one embodiment, the fiscal module 232 may be configured to deduct a percentage of the trade price, and/or a flat fee, from the buyer and/or seller in a trade. For example, the trading module 230 may execute a trade wherein the first user 108A is the buyer, and wherein the second user 108B is the seller, at a price of $25. The fiscal module 232 may be configured to deduct three percent of the trade price from the seller, and therefore in the example the fiscal module 232 deducts $0.75 from the user account 234 corresponding to the second user 108B.

The fiscal module 232 may be further configured to collect taxes from at least one of the first and second user accounts 234. The fiscal module 232 may calculate taxes based on a sales tax at the trade price. In one embodiment, the fiscal module 232 may base taxes on the location of the first user, the second user, the PMU storage facility 102, and/or any other feature of the system 100 that may apply according to the law. The fiscal module 232 may accept a user 108 input indicating that a user 108 is tax exempt.

The fiscal module 232 may be further configured to estimate a collateral value 236 of PMUs 104 corresponding to a media owner based on the ownership register 106, and to extend credit to a user account 234 corresponding to the media owner based on the collateral value 236. In one embodiment, the fiscal module 232 may be configured to estimate the collateral value 236 of PMUs 104 in the set of current PMUs 212, and to extend credit to the current user 108A based on the collateral value 236. For example, the current user 108A may own PMUs 104 listed in the current PMUs 212 worth $500 measured at a market price estimated by the trading module 230, and the fiscal module 232 may estimate a collateral value 236 of 80% of the $500, or $400. The fiscal module 232 may be configured to extend the $400 credit to the current user 108A.

The valuation of PMUs 104 owned by a user 108, and the percentages of any valuation that may comprise a collateral value 236 are business decisions for a practitioner of the present invention, and can be determined by one of skill in the art for a given system 100 based on the disclosures herein. The fiscal module 232 may be configured to estimate a collateral value 236 for any user 108, not just the current user 108A, and may estimate a collateral value 236 for any user 108, in one embodiment, by accessing the ownership register 106 to determine the PMUs 104 owned by the user 108, and valuating the PMUs 104 owned by the user 108 according to a market price from the trading module 230 and/or through general valuation principles such as a price based on the original retail price, age, and condition of each PMU 104.

The fiscal module 232 may be further configured to track a plurality of user accounts 234 corresponding to the plurality of users 108, and to deduct a PMU 104 storage fee from a user account 234 corresponding to one of the media owners based on the ownership register 106. The fiscal module 232 may be configured to determine a storage fee based on the value of PMUs 104 owned by the user 108, the type of PMU 104, the number and/or size of PMUs 104 owned by the user 108, and similar determinations. For example, three PMUs 104 comprising a Vincent van Gogh painting, a Van Halen CD, and a vinyl LP record may each incur a different storage fee. The storage fee may be a recurring and/or periodic fee.

The controller 116 may further comprise an inventory module 238 configured to accept inventory information 240 from the current user 108A. The inventory information 240 may comprise an inventory target, a buying price target, a selling price target, and a PMU designation from the current user 108A. The inventory module 238 may be further configured to interpret an inventory level 242 of the designated PMU for the current user 108A based on the ownership register 106. The inventory module 238 may interpret the inventory level 242 by utilizing the set of current PMUs 212 for the current user 108A, and/or by providing the username of the user 108 providing the inventory information 240 to the registration module 204, and retrieving the PMUs 104 owned by the user 108 from the ownership register 106. In one embodiment, the user 108A comprises the current user 108A while the inventory module 238 acts on the inventory information 240 provided by the user 108A, even if the user 108A has logged out of the system 100 or otherwise discontinues communication with the controller 116.

The inventory module 238 may be further configured to enter at least one seller-bid 224 for the designated PMU according to the selling price target whenever the inventory level 242 of the designated PMU is at least one unit of the designated PMU. The inventory module 238 may be further configured to enter at least one buyer-bid 228 for the designated PMU according to the buying price target whenever the inventory level 242 of the designated PMU is lower than the inventory target. The selling price target and the buying price target may comprise a trigger price and/or a limit price. In one embodiment the inventory module 238 sells designated PMUs whenever possible and buys designated PMUs up to the inventory target.

For example, the designated PMU may comprise a music CD “Rolling Stones Steel Wheels,” the inventory target may comprise “100 units,” the buying price target may comprise a limit price of “$11,” and the selling price target may comprise a trigger price of “$15.” In the example, the inventory module 238 may be configured to enter seller-bids 224 comprising “Rolling Stones Steel Wheels, $15 trigger price” whenever the inventory level 242 indicates that at least one of the current PMUs 212 is a “Rolling Stones Steel Wheels” music CD, and to enter buyer-bids 228 comprising “Rolling Stones Steel Wheels, $11 limit price” whenever the inventory level 242 indicates that there are fewer of the current PMUs 212 comprising a “Rolling Stones Steel Wheels” music CD than the inventory target.

The inventory information 240 may further comprise a pending buyer-bids target. The inventory module 238 may be configured to maintain a number of buyer-bids 228 for the designated PMU no greater than the pending buyer-bids target. For example, the inventory level 242 may indicate that ten copies of the designated PMU are owned, and the inventory information 240 may indicate an inventory target of one-hundred copies and a pending buyer-bid target of five copies. In the example, the inventory module 238 may be configured to enter five buyer-bids 228 for the designated PMU.

In one embodiment, the password input 210 comprises one of an access password and an ownership password. The authentication module 206 may be further configured to allow the current user 108A access to content of the current PMUs 212 if the password input 210 comprises either the access password or the ownership password. The authentication module 206 may be configured to allow the current user 108A to enter seller-bids 224 and buyer-bids 228 if the current user 108A enters the ownership password as the password input 210. For example, a user 108 on a public access computer 120 may wish to access content of current PMUs 212 belonging to the user 108, but may not wish to risk exposing a password allowing buy and sell access to their account 234 to be recovered from the public computer 120. In another example, a parent may maintain the ownership password to control the buying and selling of PMUs 104, and provide an access password to a child.

In one embodiment, the authentication module 206 may allow only one password input 210 to access the user account 234 simultaneously. For example, if a child accesses the controller 116 with the access password, the ownership password may not function if the parent simultaneously tries to access the controller 116, or the ownership password may override and disconnect the child from access to the controller 116. In another embodiment, the authentication module 206 may accept multiple logins using passwords (ownership and/or access) related to the same user account 234, but the content control module 214 may be configured to prevent identical PMU 212 content from being accessed simultaneously. For example, the content control module 214 may prevent the parent and the child from accessing the same music CD simultaneously to impose a licensing limitation associated with the music CD.

In one embodiment, the password input 210 further comprises an inventory password, and the authentication module 206 is further configured to allow the current user 108A to enter inventory information 240 in response to the current user 108A entering the inventory password. For example, the owner of an online music store may have an inventory password to set inventory levels and purchase prices for various PMUs 104. The owner of the store may provide an access password to sales staff to be able to play music samples of the current PMUs 212 for potential customers, and an ownership password to managers to allow managers to make individual purchases of PMUs 104 and sales of current PMUs 212. Other configurations of the passwords are possible and contemplated within the scope of the invention. Although in the current example, the inventory password is described as superior to the ownership password, in some embodiments the ownership password may be superior to the inventory password. Further permissions and associations with the password input 210 are possible—including limiting the ability to request credit and make transactions with the user account 234 to certain password classes.

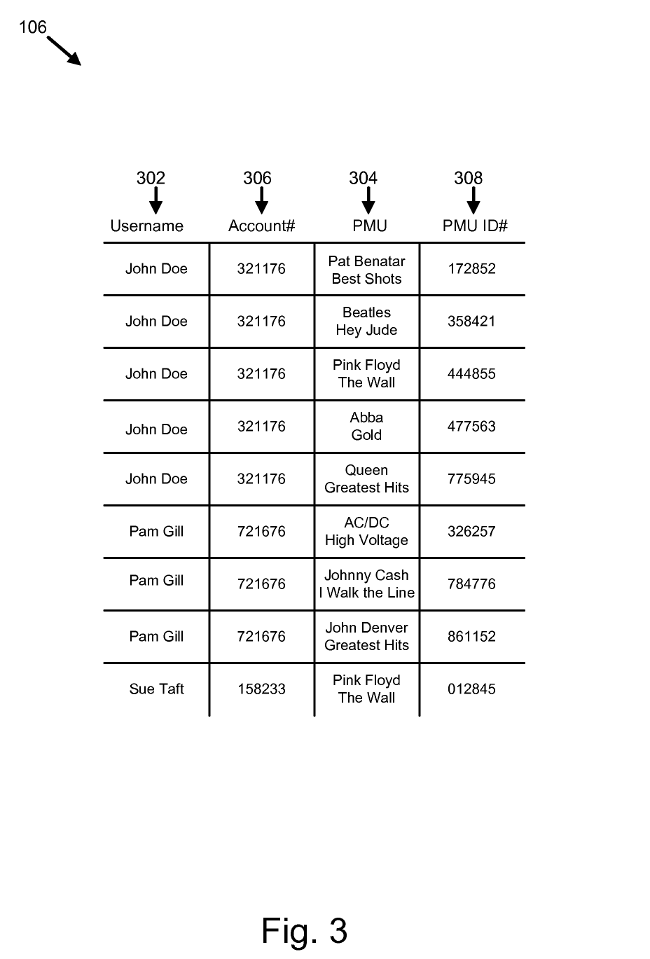

FIG. 3 is an illustration of one embodiment of an ownership register 106 in accordance with the present invention. The ownership register 106 may be a table of an ownership database. The ownership register 106 comprises a plurality of users 108, a plurality of media owners 302, each media owner 302 corresponding to one of the plurality of users 108. The ownership register 106 may further comprise a plurality of PMUs 304, each PMU 304 corresponding to one of the media owners 302. In one embodiment each user 108 and/or media owner 302 may have an account 306 comprising an account number 306. In one embodiment each PMU 304 comprises one of the PMUs 104, and may have a unique PMU identification number 308.

In one embodiment each account 306 may be maintained and updated by the fiscal module 232. Each account 306 may be maintained within the controller 116, or may be an account at a bank, debit card, another website such as Pay Pal, or other account. The PMU identification number 308 identifies a particular PMU 104,304. For example, a user 108 sends a damaged Pink Floyd ‘The Wall’ compact disc 112 to the PMU transfer facility 110, where the Pink Floyd compact disc is identified, given a specific PMU identification number 308, and stored in the PMU storage facility 102. The PMU storage facility 102 may store hundreds of other ‘The Wall’ compact discs. Later, the user 108 requests a delivery of the Pink Floyd ‘The Wall’ compact disc. The PMU transfer facility 110 will retrieve the damaged Pink Floyd ‘The Wall’ compact disc using the PMU identification number 308, and return the compact disc 122 to the user 108.

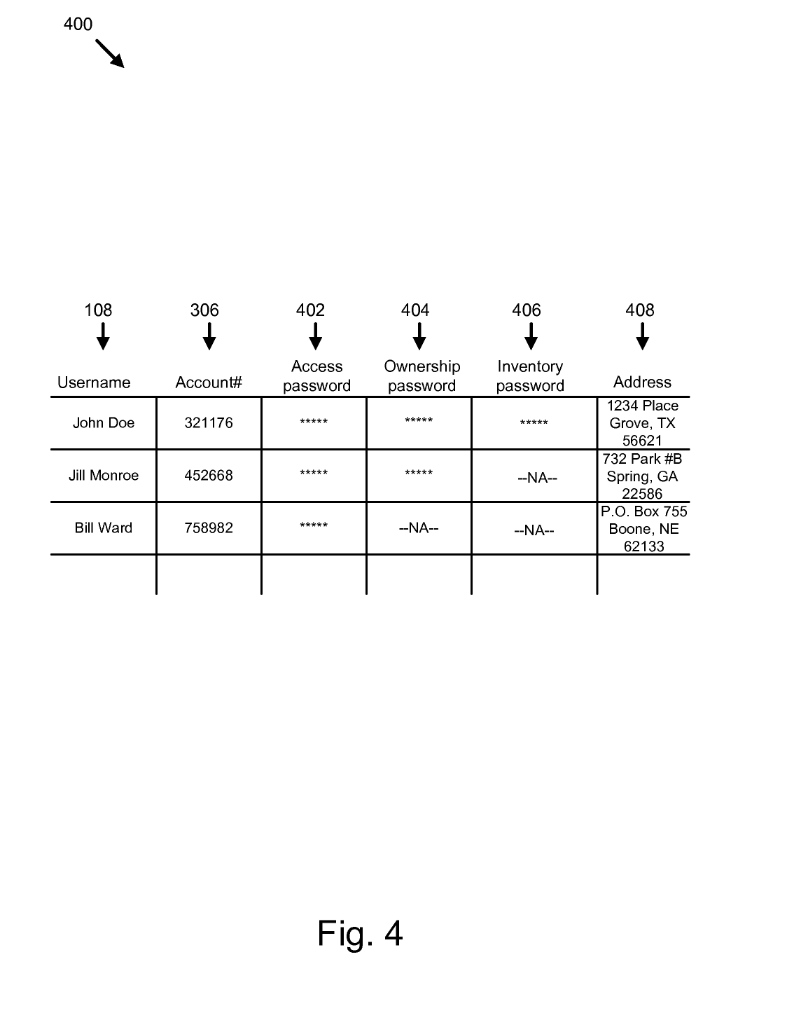

FIG. 4 is an illustration depicting one embodiment of authentication information 400 in accordance with the present invention. The authentication information 400 may be a table of an ownership database. The authentication information 400 may comprise access authentication information 402 for each user 108, and/or ownership authentication information 404 for each user. In one embodiment the authentication information 400 may further comprise inventory authentication information 406. The ownership database may further comprise a physical address record 408 corresponding to each of the users 108. In one embodiment the physical address records 408 may be stored in a table with the authentication information 400.

In one embodiment, the authentication information 400 may comprise an access password 402, an ownership password 404, and an inventory password 406. In one embodiment, each user may have one or more of the passwords 402, 404, 406. The authentication module 206 may allow the current user 108A access to the content of the current PMUs 212 in response to the current user 108A entering the access authentication information 402. The authentication module 206 may allow the current user 108A access to the content of the current PMUs 212, allow the current user 108A to place seller-bids 124, and allow the current user 108A to place buyer bids 128, in response to the current user 108A entering the ownership authentication information 404.

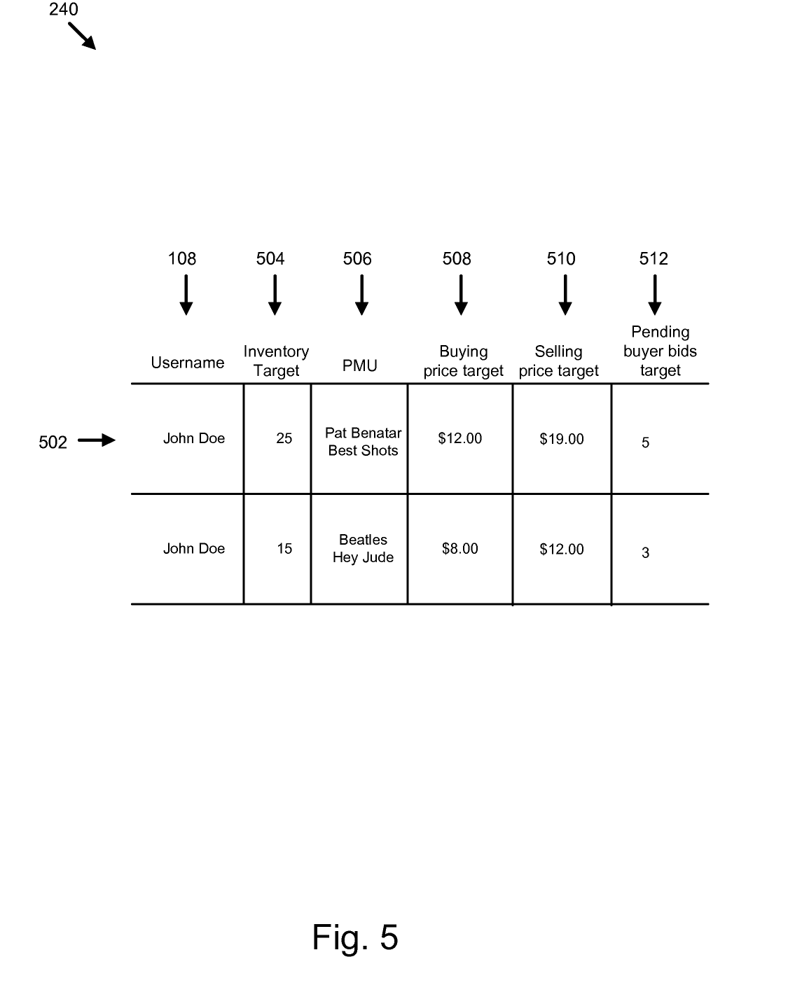

FIG. 5 is an illustration depicting one embodiment of inventory information 240 in accordance with the present invention. In one embodiment, the inventory information 240 may be stored in an ownership database as an inventory record 502 associated with one of the users 108. The ownership database may comprise a set of inventory records 502, each record 502 associated with one of the users 108. The inventory information 240 may comprise a username for the associated user 108, an inventory target 504, a PMU designation 506, a buying price target 508, a selling price target 510, and a pending buyer-bids target 512. In one embodiment, the authentication module 206 may allow the current user 108A to enter inventory information 240 in response to the current user 108A entering the inventory authentication information 406.

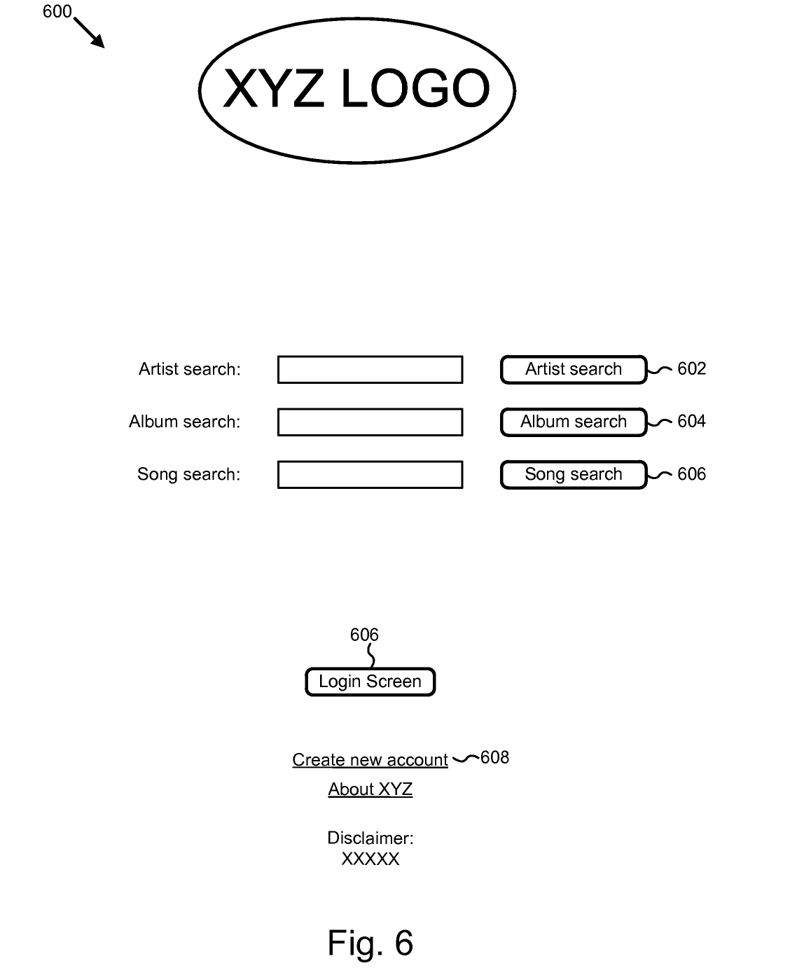

An apparatus for managing media ownership is disclosed. The apparatus comprises a remote access system. One embodiment of a remote access system is illustrated in FIGS. 6 through 10. The remote access system is depicted as a web site comprising various screens that allow the controller 116 to interact with users 108. However, the remote access system may comprise any remote communications known in the art. For example, a telephone system, computer bulletin board, file transfer protocol (FTP) system, a Secure Shell (SSH) connection, and other remote access systems known in the art may be utilized.

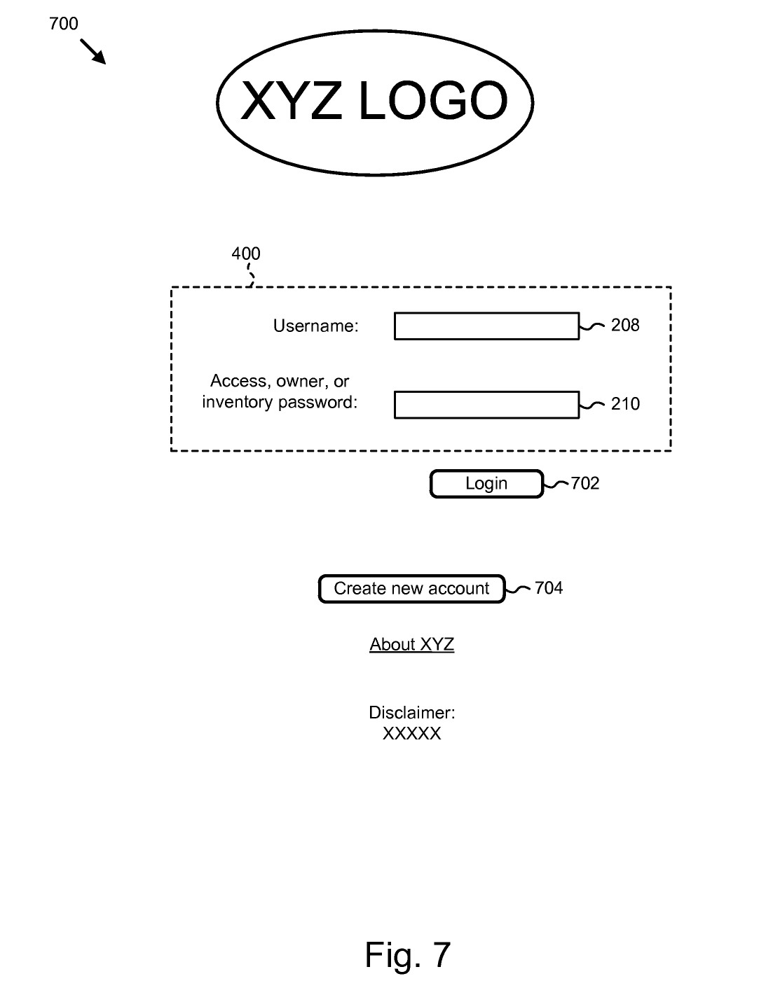

FIG. 6 is an illustration depicting one embodiment of a web site title screen 600 of a remote access system in accordance with the present invention. The web site title screen 600 may comprise an artist search selection 602, an album search selection 604, and a song search selection 606. In one embodiment, the search selections 602, 604, 606 will cause the controller 116 to find and display albums 104 comprising the artist, song, and/or album searched against, wherein the displayed albums 104 comprise a set of seller-specified PMUs from currently active seller-bids 224. The controller 116 may further list seller limit prices and/or market prices associated with the set of seller-specified PMUs. The web title screen 600 may further comprise a link 606 to a login screen 700 (refer to the description referencing FIG. 7).

FIG. 7 is an illustration depicting one embodiment of a web site login screen 700 of a remote access system in accordance with the present invention. The web site login screen 700 may comprise an input area for authentication information 400. The authentication module 206 may interpret a username input 208 and a password input 210 to authenticate the current user 108A as the media owner 302 for a set of current PMUs 212. The password input 210 may comprise an access password 402, an owner password 404, and/or an inventory password 406.

The web site login screen 700 may further comprise a login button 702 that submits the authentication information 400 to the authentication module 206. The web site login screen 700 may further comprise a button 704 to create a new user account 234. The authentication module 206 may create the user account 234 for the current user 108A in response to activation of the create new account button 704.

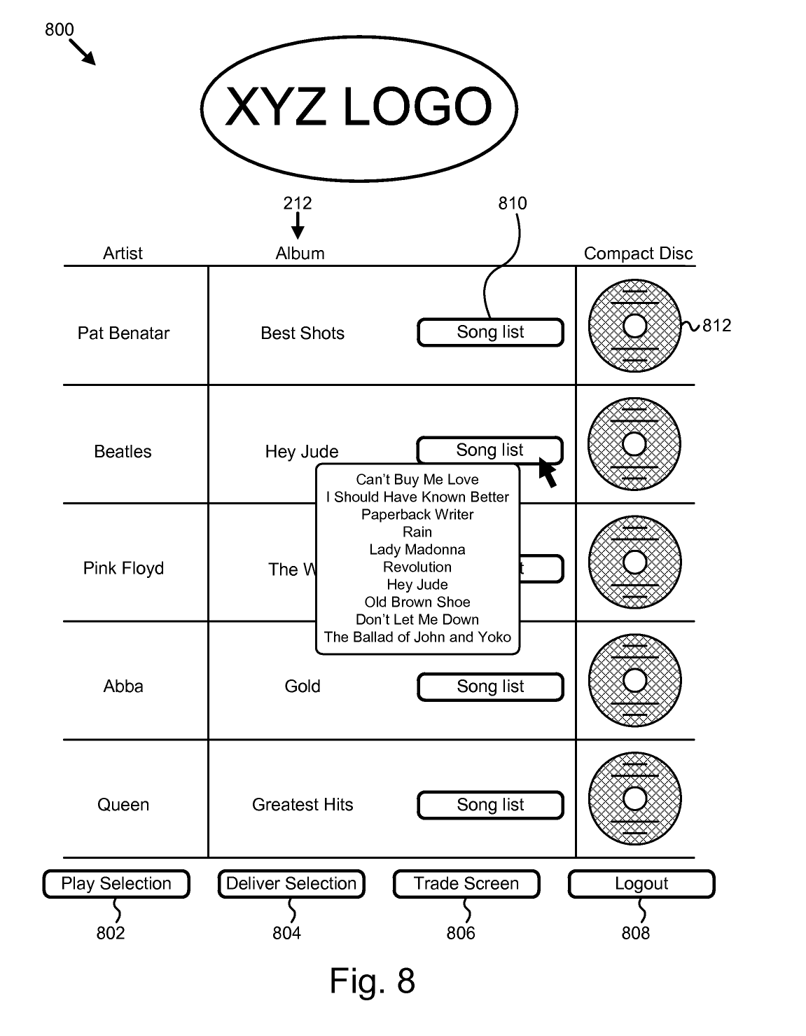

FIG. 8 is an illustration depicting one embodiment of a web site content control screen 800 of a remote access system in accordance with the present invention. The web site content control screen 800 may receive ownership rights 216 information from the current user 108A. The ownership rights 216 information may comprise: an access request 802 which may be a “play selection” button 802, a delivery request 804 which may be a “deliver selection” button 804, and a trade request 806 which may be a “trade screen” button 806. The web site content control screen 800 may further comprise a “logout” button 808.

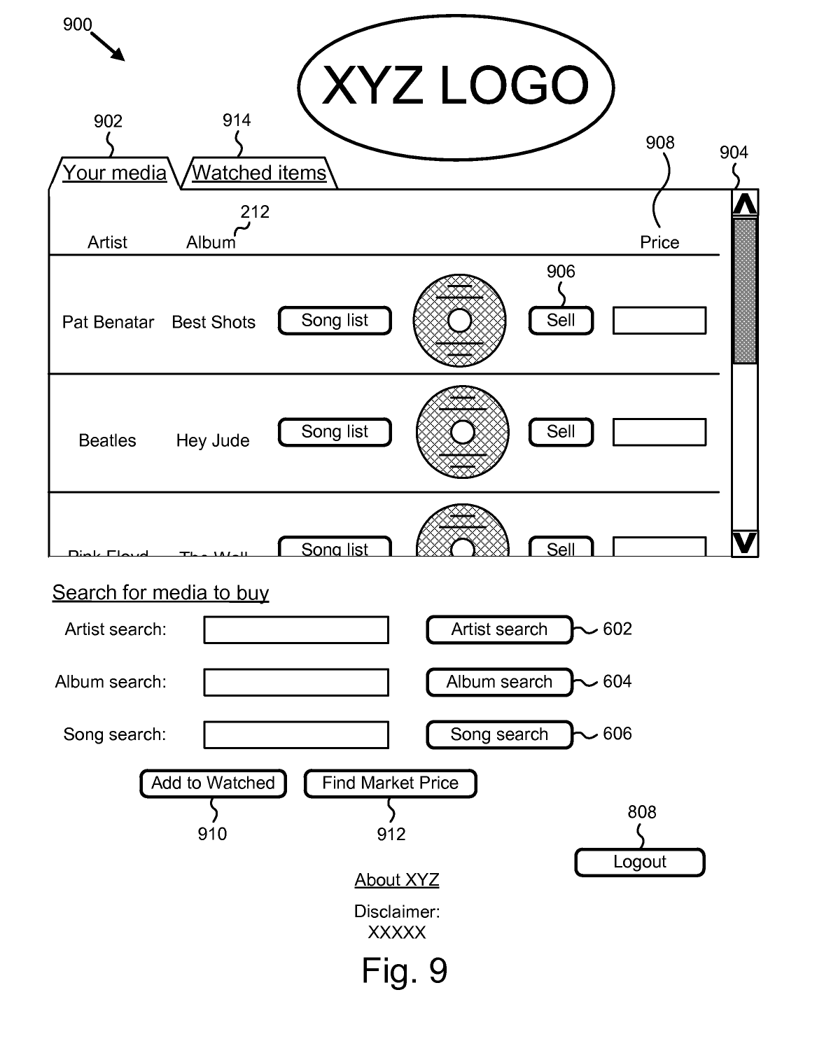

The content control module 214 may provide the current user 108A with access to the content of a PMU 212 in response to the current user 108A selecting the “play selection” button 802. For example, the content control module 214 may stream the contents of a selected PMU 212 over the internet to the user 108A. The content control module 214 may deliver a selected PMU 212 to the current user 108A selecting the “deliver selection” button 804. In one embodiment, delivery comprises physically sending the PMU 212 to a destination indicated by the user. In another embodiment, delivery comprises making the content of the PMU 212 available for download to a download location indicated by the user. The content control module 214 may open a trading screen 900 (Refer to FIG. 9) in response to the current user 108A selecting the “trade screen” button 806.

In one embodiment, the web site content control screen 800 may include a “song list” button 810, and the content control module 214 may list the songs on a selected PMU 212 in response to the current user 108A selecting the “song list” button 810. The “song list” button 810 may comprise a scene selection index where the PMUs 212 are movie DVDs, and similar content previews may be shown depending upon the type of content on the PMUs 212. The web site content control screen 800 may further comprise a picture 812 of each PMU 212. The pictures 812 may be a thumbnail picture that can be expanded, a scan of the actual PMU 212—for example indicating any distinguishing marks or damage of the PMU 212, and/or a generic picture of the PMU 212 such as a picture supplied by the manufacturer of the PMU 212.

The web site content control screen 800 may further include any information and interfaces deemed useful and known in the art. For example, the PMUs 212 may be contained in a frame with a scroll bar where too many PMUs are in the set of current PMUs 212 to fit one a standard web site content control screen 800. The web site content control screen 800 may comprise information about the current market price of each PMU 212. In one embodiment, the web site content control screen 800 may include additional information upon the payment by the user 108A of a premium subscription price to access the system 100.

FIG. 9 is an illustration depicting one embodiment of a web site trading screen 900 of a remote access system in accordance with the present invention. The web site trading screen 900 may comprise a “Your media” tab 902 depicting the set of current PMUs 212 for the current user 108A. The tab 902 may comprise a scroll bar 904 to allow the current user 108A to scroll through the set of current PMUs 212.

The tab 902 may comprise a “sell” button 906 for each PMU 212, wherein the selling module 222 may accept a seller-bid 224 in response to the current user 108A selecting the “sell” button 906. In one embodiment, the tab 902 may further comprise a “price” field 908, and the selling module 222 may accept a seller-bid 224 as a market bid when the current user 108A selects the “sell” button 906 with the “price” field 908 empty, and as a limit bid at the value of the “price” field 908 when the current user 108A selects the “sell” button 906 with the “price” field 908 containing a value.

In one embodiment, the web site trading screen 900 may include a search section that allows the current user 108A to search PMUs 104 based on the artist 602, the album 604, and by song 606. The current user 108A may select an “add to watched” button 910 to add a selected PMU 104 to a “Watched items” tab 914, and a “find market price” button 912 to find the current market price of a selected PMU 104. The web site trading screen 900 may include a “logout” button 808.

In one embodiment, the web site trading screen 900 may include a “watched items” tab 914 which may show a list of PMUs 104 selected by the current user 108A. In the embodiment depicted in FIG. 9, the “your media” tab 902 is selected and the contents of the “watched items” tab 914 are not shown. The “watched items” tab 914 may comprise a “buy” button and “price” field analogous to the “sell” button 906 and “price” field 908 on the “your media” tab 902. Other means of providing potential PMUs 104 for buying and selling to the current user 108A are understood in the art, and the current web site trading screen 900 implementation is shown only as one example.

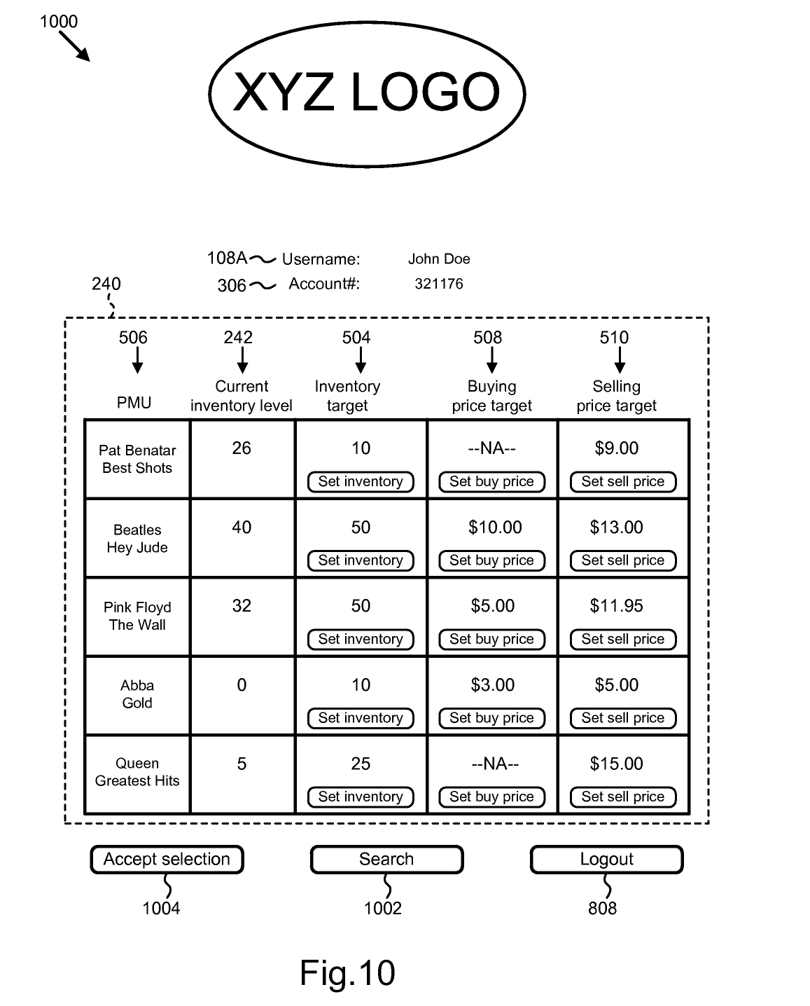

FIG. 10 is an illustration depicting one embodiment of a web site inventory screen 1000 in accordance with the present invention. The web site inventory screen 1000 may comprise inventory information 240 corresponding to the current user 108A. The web site inventory screen 1000 may comprise interfaces to set the inventory target 504, buying price target 508, and selling price targets 510 for each designated PMU 506. For example, the PMU 506 “Pat Benetar Best Shots” comprises an inventory target 504 of 10 units, a buying price target 508 equal to a null value “—NA—”, and a selling price target 510 of $9.00. In one example, the inventory module 238 will set a seller-bid 224 as a limit bid comprising the PMU designation of “Pat Benetar Best Shots,” and a price of $9.00 whenever the current inventory level 242 indicates that some of the designated PMU 506 are in stock.

In one embodiment, the buying price target 508 equal to a null value may indicate that the inventory module 238 will not enter a buyer-bid 228 for the designated PMU 506. In an alternative embodiment, the buying price target 508 equal to a null value may indicate that the inventory module 238 will enter a market bid for the designated PMU 506. The web site inventory screen may comprise a user interface (not shown) to select how the inventory module 238 treats a null bid for the buying price target 508 and/or selling price target 510. In one example, the buying price target 508 may be a null value when a user 108A does not buy the designated PMU 506 on the system 100, but rather buys the designated PMU 506 wholesale, and transfers the PMUs 506 as incoming PMUs 112 to the PMU transfer facility 110 to replenish the current inventory level 242 of the designated PMU 506 after units of the designated PMU 506 are sold.

The web site inventory screen 1000 may further comprise a “search” button 1002 whereby the current user 108A may find and select designated PMUs 506, an “accept selection” button 1004 whereby the current user 108A may accept the currently displayed information, and a “logout” button 808. Other buttons, interfaces, and layouts of the inventory information 240 and web site inventory screen 1000 may be utilized in a given embodiment of the present invention.

The particular layouts, types of media content, and other information provided for the example embodiment of the remote access system shown in FIGS. 6 through 10 should not be read as limiting the scope of the present invention. The layouts and media types are depicted to illustrate one embodiment of the invention, and it is a mechanical step for one of skill in the art to utilize different layouts, remote access formats and protocols, and to customize a remote access interface for other types of PMUs.

The schematic flow chart diagrams herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

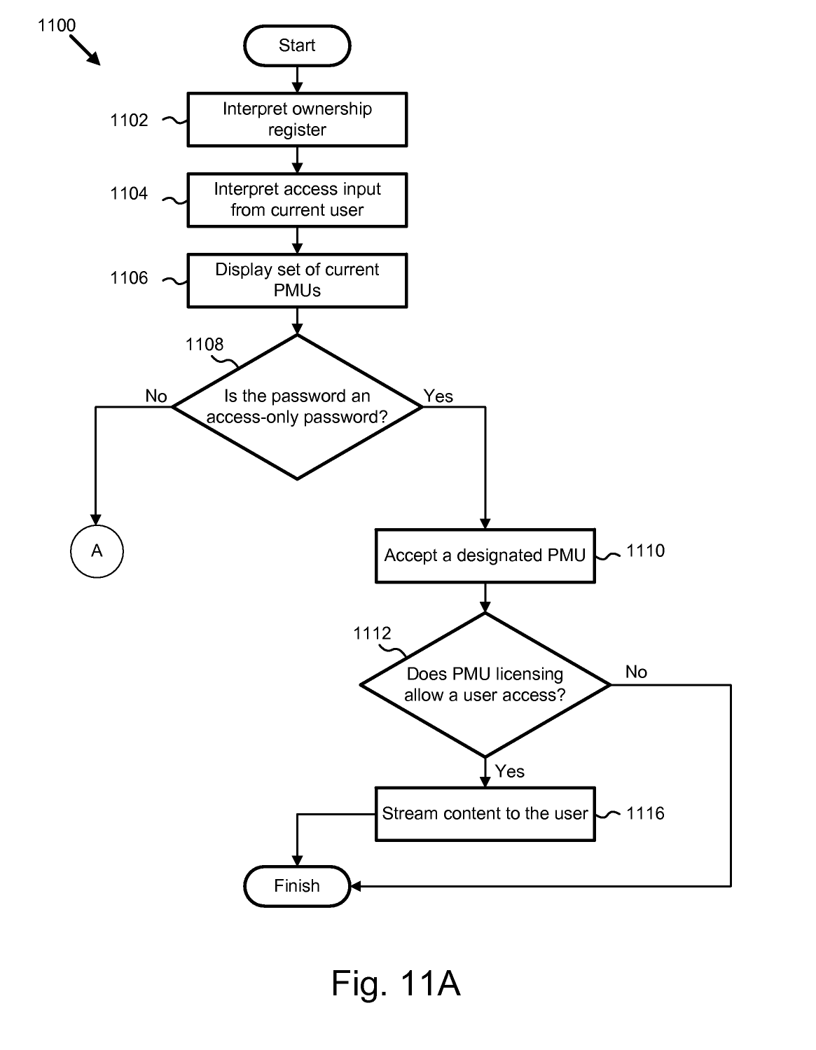

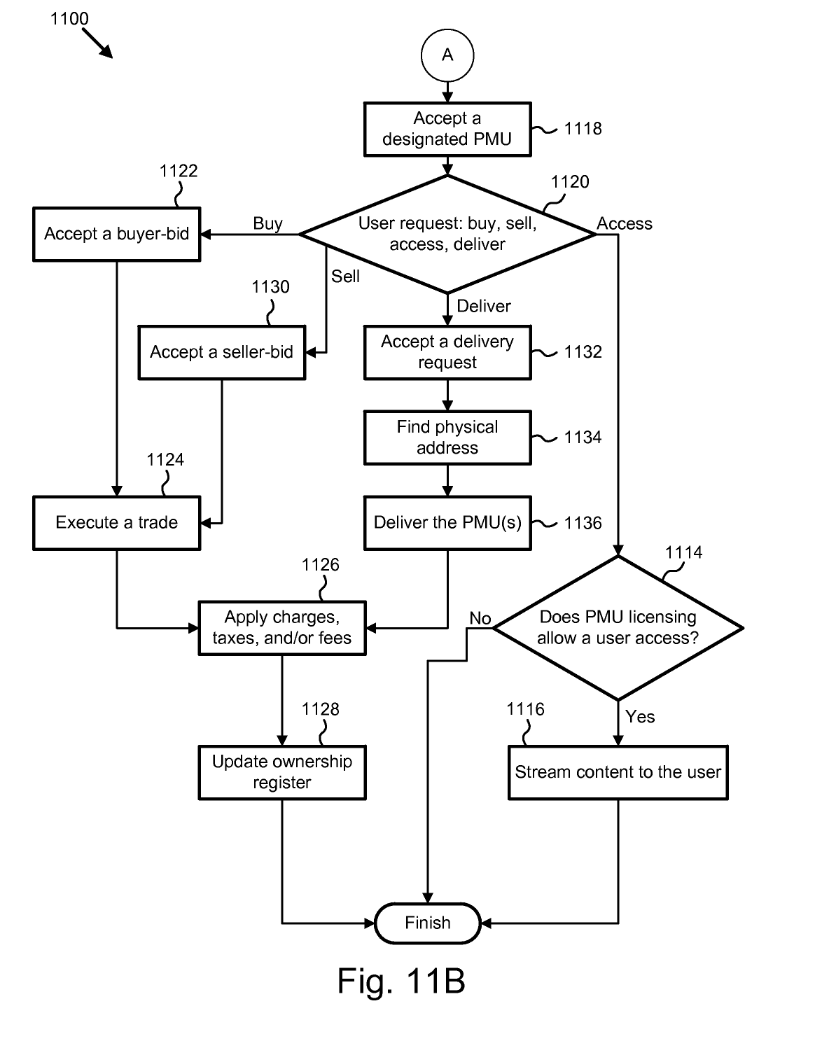

FIG. 11A is a schematic flow diagram illustrating one embodiment of a method 1100 for managing remote media ownership in accordance with the present invention. The method 1100 includes a registration module 204 interpreting 1102 an ownership register 106. The method 1100 further includes an authentication module 206 interpreting 1104 access input from a current user 108A, and authenticating the current user 108A as the media owner 302 for a set of current PMUs 212 according to the access input 208, 210 and the ownership register 106. The method 1100 may further include the content control module 214 displaying 1106 the set of current PMUs 212 to the current user 108A.

The method 1100 further includes a content control module 214 managing ownership rights 216 regarding the set of current PMUs for the current user 108A. In one embodiment, the content control module 214 checks 1108 if the password 210 is an access-only password 402. If the check 1108 is positive, the content control module 214 may accept 1110 a designated PMU from the set of current PMUs 212 in response to input from the current user 108A. The content control module 114 may check 1112 if the licensing for the designated PMU allows a current user 108A access. For example, if the licensing for the designated PMU indicates that only one user 108 may access the PMU at a time, and another user 108 is logged in to the same user account 234 and accessing the designated PMU, the check 1112 may return a “No” value, indicating that the licensing for the designated PMU does not allow the current user 108A access. If the check 1112 returns a positive value, the content control module 114 may provide the current user 108A access to the designated PMU, for example by streaming 1116 the content of the PMU to the current user 108A. The content control module 214 thereby limits ownership rights to the right to use PMUs from the set of PMUs in response to the login password 210 matching the access password 402.

If the check 1108 returns a value indicating that a full ownership password 404 was entered by the current user 108A, the content control module 214 may accept 1118 (Refer to FIG. 11A) a designated PMU from the current user 108A. The content control module 114 may then check 1120 if a current user request is a buy, sell, access, or delivery request. If the check 1120 indicates a buy request, the buying module 226 may accept 1122 a buyer-bid 228, and the trading module 230 may execute 1124 a trade if the system 100 comprises a matching seller-bid 224 such that the trade can be executed 1124 according to the buyer-bid 228 and the seller-bid 224. The fiscal module 232 may apply 1126 charges, taxes, and/or fees to the user accounts 234 of the buyer and seller in the executed 1124 trade. The registration module 204 may receive instructions from the trading module 230 about the trade, and update 1128 the ownership register 106 based on the trade.

If the check 1120 indicates a sell request, the selling module 222 may accept 1130 a seller-bid 224, and the trading module 230 may execute 1124 a trade if the system 100 comprises a matching buyer-bid 228 such that the trade can be executed 1124 according to the buyer-bid 228 and the seller-bid 224. The fiscal module 232 may apply 1126 charges, taxes, and/or fees to the user accounts 234 of the buyer and seller in the executed 1124 trade. The registration module 204 may receive instructions from the trading module 230 about the trade, and update 1128 the ownership register 106 based on the trade.

If the check 1120 indicates a delivery request, the content control module 214 may accept 1132 a delivery request. The content control module 214 may find 1134 the physical address of the current user 108A—for example by accepting a user 108A input, by accessing the ownership register 106, and the like. The content control module 214 may deliver 1136 the PMU(s) requested by notifying the PMU transfer facility 110 of the request. The fiscal module 232 may apply 1126 charges, taxes, and/or fees to the user account 234 of the current user 108A according to the terms of an agreement between the current user 108A and an administrator (not shown) of the system 100. The registration module 204 may receive instructions from the content control module 214 about the delivery, and update 1128 the ownership register 106 based on the delivery.

The content control module 214 may be configured to allow access to the content of the designated PMU as described in FIG. 11A where the check 1108 indicates that the access-only password 402 is supplied by the current user 108A. The content control module 214 may thereby manage ownership rights 216 to the right to use, to dispose of, and to possess PMUs from the set of current PMUs 212.

From the foregoing discussion, it is clear that the invention provides a system, method, and apparatus for managing remote media ownership. The invention overcomes previous limitations in the art by allowing users (consumers) to access and trade physical media content without the constraints and risks of maintaining the physical media units at the location of the consumer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a physical media unit (“PMU”) and ownership information corresponding to the PMU, the PMU and the ownership information received from a media owner, the PMU comprising a storage medium for media content;
storing the PMU in a physical media storage facility in response to receiving the PMU and ownership information;
updating an ownership register to associate the PMU with the media owner and with digital media content, the digital media content one or more of derived from media content of the PMU, equivalent to media content of the PMU, stored on the PMU, and copied from the PMU;
receiving, with an authentication module, authentication information input from a current user;
authenticating, with the authentication module, the current user as the media owner for the PMU according to the authentication information received from the current user and the ownership register;
managing, with a content control module, first ownership rights for the current user in response to authenticating the current user as the media owner, the first ownership rights comprising one or more of a right of the current user to use the PMU, a right of the current user to dispose the PMU, and a right of the current user to possess the PMU; and
managing, with a content control module, second ownership rights for the current user in response to authenticating the current user as the media owner, the second ownership rights comprising a right of the current user to use the digital media content associated with the PMU.

2. The method of claim 1, further comprising:
accepting, form a first user, a seller-bid of a seller-specified PMU, the first user comprising a media owner of the seller-specified PMU, the seller-bid soliciting bids for the seller-specified PMU owned by the first user from one or more potential buyers;
accepting, from a second user, a buyer-bid of a buyer-specified PMU; and
executing a PMU trade in response to the seller-specified PMU matching the buyer specified PMU.

3. The method of claim 2, wherein the seller-bid and the buyer-bid each comprise a member selected from the group consisting of a market order, a stop order, and a limit order.

4. The method of claim 1, wherein the authentication information comprises a username and a login password, the login password comprising one of an access password and an ownership password, and wherein the method further comprises limiting ownership rights to the right to use digital media content for the PMU in response to the login password matching the access password.

5. An apparatus for managing media ownership, the apparatus comprising:
an ownership database associating a physical media unit (“PMU”) with a media owner and with digital media content, the PMU and ownership information corresponding to the PMU received at a PMU transfer facility from the media owner, the PMU comprising a storage medium for media content, the PMU stored in a physical media storage facility in response to receiving the PMU and ownership information, the digital media content one or more of derived from media content of the PMU, equivalent to media content of the PMU, stored on the PMU, and copied from the PMU;
a remote access system implemented with a processor and a memory, the remote access system comprising:
an authentication module programmed to receive authentication information and to authenticate a current user as the media owner for the PMU according to the authentication information and the ownership register;
a content control module programmed to
interpret access request information from the current user, the access request information comprising one of a content delivery request and a physical delivery request for the PMU,
send digital media content associated with the PMU to the current user in response to a content delivery request,
send the PMU to the current user in response to a physical delivery request,
administer first ownership rights for the current user in response to authenticating the current user as the media owner, the first ownership rights comprising one or more of a right of the current user to use the PMU, a right of the current user to dispose of the PMU, and a right of the current user to possess the PMU according to the access request information,
administer second ownership rights comprising a right of the current user to use the digital media content associated with the PMU; and
a trading module programmed to interpret a buy option allowing the current user to place buyer-bids on additional PMUs, and to interpret a sell option allowing the current user to place seller-bids on the PMU.

6. The apparatus of claim 5, wherein the ownership database comprises an access authentication information and an ownership authentication information for each of a plurality of users, wherein the authentication module allows access to the digital media content associated with the PMU in response to the current user entering the access authentication information, and allows access to the digital media content associated with the PMU, to place seller-bids, and to place buyer-bids in response to the current user entering the ownership authentication information.

7. The apparatus of claim 6:
wherein the ownership database further comprises a set of inventory records, each inventory record comprising a PMU designation, an inventory target, a buying price target, and a selling price target, wherein each inventory record is associated with one of a plurality of users;
wherein the remote access system further comprises:
an inventory module programmed to interpret an inventory PMU designation, an inventory target input, a buying price target input, and a selling price target input from the current user;
the inventory module further programmed to place a buyer-bid based on the buying price target input for the inventory-designated PMU in response to a current inventory level of the inventory-designated PMU being lower than the inventory target, and to place a seller-bid based on the selling price target input for the inventory-designated PMU in response to the current inventory level of the inventory-designated PMU being at least one PMU.

8. The apparatus of claim 5, wherein the ownership database further comprises a physical address record corresponding to each of a plurality of users, and wherein the content control module is further programmed to initiate delivery of the PMU to the physical address record corresponding to the current user in response to a physical delivery request.

9. A system for managing media ownership, the system comprising:
a PMU transfer facility configured to receive, from a media owner, a physical media unit (“PMU”) and ownership information corresponding to the PMU, the PMU comprising a storage medium for media content, wherein:
the PMU transfer facility is configured to store the PMU in a physical media storage facility and update an ownership register in response to receiving the PMU and the ownership information;
the physical media storage facility has a plurality of receptacles to store a plurality of PMUs, the physical media storage facility comprising a physical facility for storing physical objects; and
the ownership register is configured to associate the PMU with the media owner and with digital media content, the digital media content one or more of derived from media content of the PMU, equivalent to media content of the PMU, stored on the PMU, and copied from the PMU, wherein each media owner comprises one of a plurality of users, each user comprising a legal entity;
a controller implemented with a processor and a memory, the controller comprising:
a registration module programmed to manage the ownership register;
an authentication module programmed to interpret a username input and a password input from a current user, and to authenticate the current user as the media owner for the PMU according to the username input, the password input, and the ownership register; and
a content control module programmed to manage first ownership rights for the current user in response to authenticating the current user as the media owner, the first ownership rights comprising one or more of a right of the current user to use the PMU, a right of the current user to dispose of the PMU, and a right of the current user to possess the PMU and programmed to manage second ownership rights for the current user in response to authenticating the current user as the media owner, the second ownership rights comprising a right of the current user to use the digital media content associated with the PMU.

10. The system of claim 9, the controller further comprising:
a selling module programmed to accept a seller-bid comprising a seller-specified PMU;
a buying module programmed to accept a buyer-bid comprising a buyer-specified PMU;
a trading module programmed to execute a PMU trade in response to the seller-specified PMU matching the buyer-specified PMU, and to update the ownership register based on the PMU trade.

11. The system of claim 10, wherein the seller-bid further comprises a seller trigger price, wherein the trading module is further programmed to execute the PMU trade only after a trigger PMU sale of greater than the seller trigger price, wherein the trigger PMU sale comprises a PMU matching the seller-specified PMU.

12. The system of claim 10, wherein the buyer-bid further comprises a buyer trigger price, wherein the trading module is further programmed to execute the PMU only after a trigger PMU sale of less than the buyer trigger price, wherein the trigger PMU sale comprises a PMU matching the buyer-specified PMU.

13. The system of claim 10, wherein the seller-bid further comprises a seller limit price, wherein the trading module is further programmed to execute the PMU trade only when an available buyer-bid allows the PMU trade to occur at a price of at least the seller limit price.

14. The system of claim 10, wherein the buyer-bid further comprises a buyer limit price, wherein the trading module is further programmed to execute the PMU trade only when an available seller-bid allows the PMU trade to occur at a price no greater than the buyer limit price.

15. The system of claim 10, wherein the controller further comprises a fiscal module programmed to deduct a trade price from a first use account corresponding to a first user associated with the buyer-bid, and to add the trade price to a second user account corresponding to a second user associated with the seller-bid.

16. The system of claim 15, wherein the fiscal module is further programmed to deduct at least one commission from at least one of the first user account and the second user account.

17. The system of claim 15, wherein the fiscal module is further programmed to collect taxes from at least one of the first user account and the second user account.

18. The system of claim 9, wherein the controller further comprises a fiscal module programmed to estimate a collateral value of PMUs corresponding to a media owner based on the ownership register, and to extend credit to a user account corresponding to the media owner based on the collateral value.

19. The system of claim 9, wherein the controller further comprises a fiscal module programmed to track a plurality of user accounts corresponding to a plurality of users, the fiscal module further programmed to deduct a PMU storage fee from a user account corresponding to a media owner based on the ownership register.

20. The system of claim 10, wherein the password input comprises one of an access password and an ownership password, and wherein the authentication module is further programmed: to allow the current user access to digital media content of the PMU in response to the current user entering the access password; and to allow the current user access to digital media content of the PMU, to enter seller-bids, and to enter buyer-bids in response to the current user entering the ownership password.

21. The system of claim 9, wherein the right to use digital media content associated with the PMU comprises access to a digital media equivalent of at least a portion of the media content of the PMU.

22. The system of claim 21, wherein the incoming PMU comprises a damaged PMU, the system further comprising a media verification module programmed to identify the damaged PMU as an acceptable representation of ownership of the media content of the PMU, and wherein the digital media equivalent of at least a portion of the media content of the damaged PMU comprises a digital media equivalent of the undamaged media content of the damaged PMU.

23. The system of claim 10, wherein the controller further comprises an inventory module programmed to:
accept an inventory target, a buying price target, a selling price target, and a PMU designation from the current user;
interpret an inventory level of the designated PMU for the current user based on the ownership register;
enter at least one seller-bid for the designated PMU according to the selling price target whenever the inventory level of the designated PMU is at least one unit; and
enter at least one buyer-bid for the designated PMU according to the buying price target whenever the inventory level of the designated PMU is lower than the inventory target.

24. The system of claim 23, wherein the password input comprises an inventory password, and wherein the authentication module is further programmed to allow the current user to enter an inventory target, a buying price target, a selling price target, and a PMU designation in response to the current user entering the inventory password.

25. The system of claim 23, wherein the inventory module is further programmed to accept a pending buyer-bids target, wherein the inventory module is further programmed to maintain a number of buyer-bids for the designated PMU no greater than the pending buyer-bids target.

26. The system of claim 9, wherein the content control module is further programmed to accept a delivery order from the current user for the PMU, and to initiate a delivery of the PMU in response to the delivery order.

27. The system of claim 9, wherein each PMU comprises a member selected from the group consisting of a medium for audio content, a medium for video content, a medium for digital game content, and a medium for multimedia content.

28. The system of claim 9, wherein each PMU comprises a member selected from the group consisting of a vinyl audio record, and a magnetic tape, wherein the right to use digital media content associated with the PMU comprises access to a digital representation of the PMU.
